(19) United States
(12) Patent Application Publication
(10) Pub. No.: US 2025/0199857 A1
(43) Pub. Date: Jun. 19, 2025

(54) ELECTRONIC DEVICE AND METHOD WITH TENSOR MANAGEMENT AND PREFETCHING

(71) Applicant: Samsung Electronics Co., Ltd., Suwon-si (KR)

(72) Inventors: Ruth KIM, Suwon-si (KR); Jungsik CHOI, Suwon-si (KR); Wonik SEO, Suwon-si (KR); Seok-Young YOON, Suwon-si (KR)

(73) Assignee: Samsung Electronics Co., Ltd., Suwon-si (KR)

(21) Appl. No.: 18/776,471

(22) Filed: Jul. 18, 2024

(30) Foreign Application Priority Data
Dec. 14, 2023 (KR) 10-2023-0181900

(51) Int. Cl. G06F 9/38; G06F 9/30

(52) U.S. Cl. CPC G06F 9/3802; G06F 9/3004

(57) ABSTRACT

A processor-implemented method includes allocating tensors to a memory to perform an initial iteration of training of a deep learning application, wherein the initial iteration is performed through execution of a plurality of kernels and, in response to each kernel being executed, tensors corresponding to the each kernel are used to execute the kernels, storing pattern information for allocating the tensors and the kernels to the memory in the initial iteration, and prefetching the tensors based on the pattern information to perform a next iteration of training of the deep learning application.

### CROSS-REFERENCE TO RELATED APPLICATIONS

This application claims the benefit under 35 USC § 119 (a) of Korean Patent Application No. 10-2023-0181900, filed on Dec. 14, 2023 in the Korean Intellectual Property Office, the entire disclosure of which is incorporated herein by reference for all purposes.

### BACKGROUND

### 1. Field

The following description relates to an electronic device and method with tensor management and prefetching.

### 2. Description of Related Art

Memories of a central processing unit (CPU) may be physically distinguished from those of a graphics processing unit (GPU). Data shared between the CPU and GPU may be allocated in both memories and may be copied explicitly in a program. Accordingly, it may be complicated for programmers to write programs. To solve this issue, a concept of a unified memory for integrating a CPU memory and GPU memory may be implemented. The unified memory allows programmers to easily write programs by providing a single virtual address space for a CPU memory and GPU memory, which are physically different memories. The unified memory may not be different from an existing virtual memory, for the unified memory operates based on demand paging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes allocating tensors to a memory to perform an initial iteration of training of a deep learning application, wherein the initial iteration is performed through execution of a plurality of kernels and, in response to each kernel being executed, tensors corresponding to the each kernel are used to execute the kernels, storing pattern information for allocating the tensors and the kernels to the memory in the initial iteration, and prefetching the tensors based on the pattern information to perform a next iteration of training of the deep learning application.

The storing of the pattern information for allocating the tensors and the kernels to the memory may include generating unique information of the tensors, and generating and storing the pattern information based on the unique information.

The unique information may include feature information of a tensor and stack information about a process of allocating the tensor to the memory.

The pattern information may include a kernel table for storing an execution order of the kernels in the initial iteration and a tensor table for storing tensors corresponding to the each kernel.

The prefetching of the tensors may include predicting kernels to be executed based on the kernel table and the tensor table and prefetching tensors corresponding to the predicted kernels.

The tensor table may be generated through a search using a self-balancing binary search tree.

The method may include managing the tensors with structures including the unique information.

The managing of the tensors may include, in response to a page fault occurring, managing the structures with a self-balancing binary search tree for searching for a structure in which the page fault occurred and managing the structures with a hash table to search for a tensor using the feature information.

The method may include training the deep learning application using the prefetched tensors.

In one or more general aspects, a processor-implemented method may include implementing the trained deep learning application, wherein the deep learning application is trained by the method and/or operations above.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes allocating tensors to a memory to perform an initial iteration of training of a deep learning application, wherein the initial iteration is performed through execution of a plurality of kernels and, in response to each kernel being executed, tensors corresponding to the each kernel are used to execute the kernels, obtaining unique information of the tensors through the initial iteration, storing pattern information for allocating the tensors and the kernels to the memory based on the unique information, and prefetching the tensors based on the pattern information to perform a next iteration of training of the deep learning application, wherein the unique information may include feature information of a tensor and stack information about a process of allocating the tensor to the memory.

In one or more general aspects, an electronic device includes one or more processors configured to allocate tensors to a memory to perform an initial iteration of training of a deep learning application, wherein the initial iteration is performed through execution of a plurality of kernels and in response to each kernel being executed, tensors corresponding to the each kernel are used to execute the kernels, store pattern information for allocating the tensors and the kernels to the memory in the initial iteration, and prefetch the tensors based on the pattern information to perform a next iteration of training of the deep learning application.

For the storing of the pattern information for allocating the tensors and the kernels to the memory, the one or more processors may be configured to generate unique information of the tensors and generate and store the pattern information based on the unique information.

The unique information may include feature information of a tensor and stack information about a process of allocating the tensor to the memory.

The pattern information may include a kernel table for storing an execution order of the kernels in the initial iteration and a tensor table for storing tensors corresponding to the each kernel.

For the prefetching of the tensors, the one or more processors may be configured to predict kernels to be executed based on the kernel table and the tensor table and prefetch tensors corresponding to the predicted kernels.

The tensor table may be generated through a search using a self-balancing binary search tree.

The one or more processors may be configured to manage the tensors with structures including the unique information.

For the managing of the tensors, the one or more processors may be configured to, in response to a page fault occurring, manage the structures with a self-balancing binary search tree for searching for a structure in which the page fault occurred and manage the structures with a hash table to search for a tensor using the feature information.

Other features and aspects will be apparent from the following detailed description, the drawings, and the claims.

### BRIEF DESCRIPTION OF THE DRAWINGS

FIG. 1 illustrates an example of transmission of memory usage information.

FIG. 2 illustrates an example of a memory usage pattern of a deep learning application.

FIG. 3 illustrates an example of an electronic device.

FIG. 4 illustrates an example of a method of operating an electronic device.

FIG. 5 illustrates an example of unique information of a tensor.

FIG. 6 illustrates an example of a method of managing tensor information.

FIG. 7 illustrates an example of management of a tensor.

FIG. 8 illustrates an example of a tensor table.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, examples will be described in detail with reference to the accompanying drawings. When describing the examples with reference to the accompanying drawings, like reference numerals refer to like components and a repeated description related thereto will be omitted.

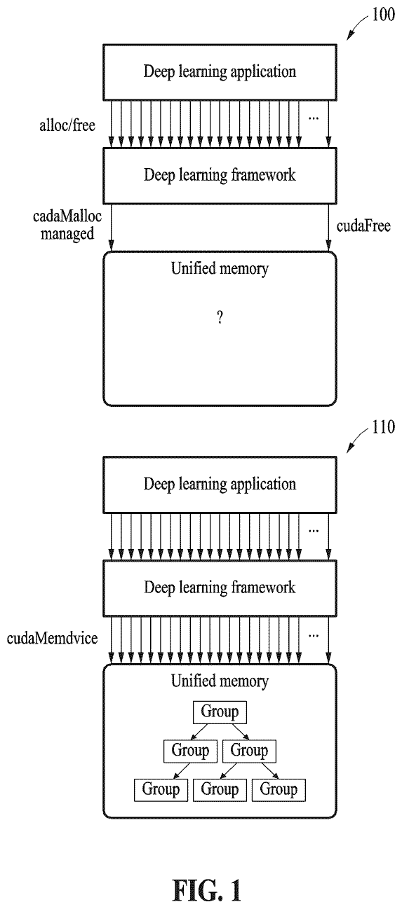

FIG. 1 illustrates an example of transmission of memory usage information.

Deep learning technology may be used in various fields such as image classification, semantic segmentation, translation, and language modeling. The size of a model in deep learning applications may increase to improve training accuracy. To support training of such large-scale deep learning applications, a unified memory that is extended to a storage device may be used. The unified memory that is extended to a storage device may have a large number of training parameters and may support training of deep learning applications in which a memory capacity required for training is very large. However, referring to a typical unified memory system 100, a unified memory may not receive memory usage information of a deep learning application from a deep learning framework. Therefore, the typical unified memory system 100 may have a technical problem in which the unified memory may not identify the memory usage information of a deep learning application. For example, the unified memory of the typical unified memory system 100 may recognize the size of the memory secured by the application and may not know how the application uses the secured memory. For memory management, the unified memory of the typical unified memory system 100 may need to receive usage information of the deep learning application. Therefore, referring to a unified memory system 110, various methods may be used to transmit the memory usage information of a deep learning application to the unified memory. For example, through a user hint, the deep learning framework may transmit the memory usage information of a deep learning application to the unified memory. In the typical unified memory system 100 and the unified memory system 110, a unified memory may refer to a unified memory system (e.g., a unified memory system implementing an operating system).

The unified memory that has received the memory usage information of a deep learning application may manage the memory in various methods based on the memory usage information. Hereinafter, a memory usage pattern included in the memory usage information of a deep learning application is described.

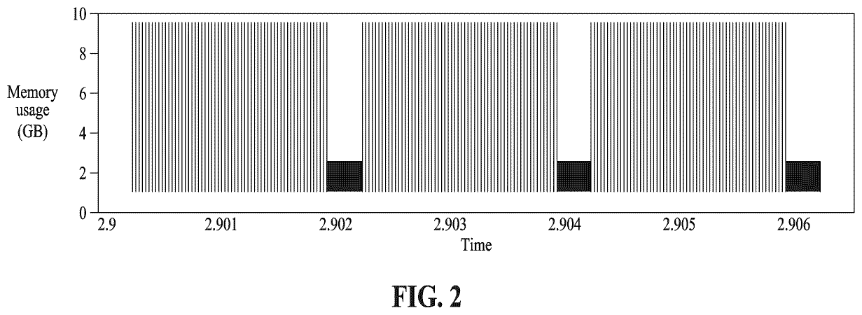

FIG. 2 illustrates an example of a memory usage pattern of a deep learning application.

Referring to FIG. 2, a memory usage pattern when the deep learning application is trained three times is illustrated. For example, the memory usage pattern when an epoch is three is illustrated. Each epoch may include a plurality of iterations. Here, a parameter of the deep learning application may be updated each time an iteration is performed. For example, when 1-epoch is performed, parameters of the deep learning application may be updated by the number of iterations of the epoch.

Referring to FIG. 2, when repeatedly mapping and unmapping data, the deep learning application may show a stricter usage pattern than a typical application. The deep learning application may use the same memory as a previous iteration in a current iteration. For example, when “1064” tensors are mapped and “1064” tensors are unmapped in a previous iteration, “1064” tensors may be mapped and “1064” tensors may be unmapped in a current iteration.

For example, the workload of the deep learning application may be repeating the same task. Therefore, the memory usage pattern of the deep learning application may have a deterministic memory usage pattern. In the present disclosure, a method of managing and prefetching tensors based on such a memory usage pattern is described.

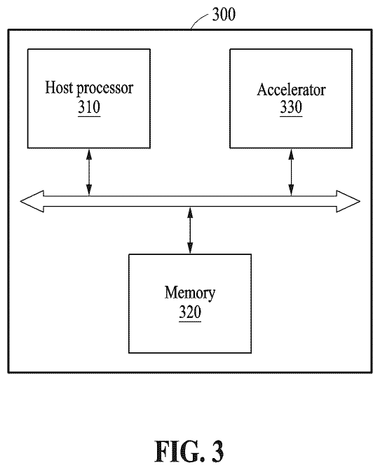

FIG. 3 illustrates an example of an electronic device.

Referring to FIG. 3, an electronic device 300 may include a host processor 310 (e.g., one or more processors), a memory 320 (e.g., one or more memories), and an accelerator 330 (e.g., one or more accelerators). The host processor 310, the memory 320, and the accelerator 330 may communicate with each other through a bus, a network on a chip (NoC), a peripheral component interconnect express (PCIe), and the like. In the example of FIG. 1, only the components related to the example described herein are illustrated in the electronic device 300. However, it will be understood by one of ordinary skill in the art with an understanding of the present disclosure that the electronic device 300 may also include other general-purpose components, in addition to the components illustrated in FIG. 3.

The host processor 310 may perform overall functions for controlling the electronic device 300. The host processor 310 may control the electronic device 300 overall by executing programs and/or instructions stored in the memory 320. For example, the memory 320 may include a non-transitory computer-readable storage medium storing instructions that, when executed by the host processor 310, configure the host processor 310 to perform any one, any combination, or all of operations and/or methods disclosed herein with reference to FIGS. 1-8. The host processor 310 may be implemented as a central processing unit (CPU), a graphics processing unit (GPU), an application processor (AP), and the like that are included in the electronic device 300, however, examples are not limited thereto.

The memory 320 may be hardware for storing data processed in the electronic device 300 and data to be processed. In addition, the memory 320 may store an application, a driver, and the like to be driven by the electronic device 300. The memory 320 may include a volatile memory (e.g., dynamic random-access memory (DRAM)) and/or a non-volatile memory.

The electronic device 300 may include the accelerator 330 for operations. The accelerator 330 may process tasks that may be more efficiently processed by a separate exclusive processor (e.g., the accelerator 330), rather than by a general-purpose host processor (e.g., the host processor 310), due to the characteristics of the tasks. One or more processing elements (PEs) included in the accelerator 330 may be utilized. The accelerator 330 may correspond to, for example, a neural processing unit (NPU), a tensor processing unit (TPU), a digital signal processor (DSP), a GPU, a neural engine, and the like that may perform an operation according to a neural network.

Operations of the electronic device 300 described in the present disclosure may be performed by the host processor 310, but the examples are not limited thereto.

As described above with reference to FIG. 2, a deep learning application may repeat the same task during training. In addition, the same memory usage pattern may always be used during training. Accordingly, the electronic device 300 may store the memory usage pattern of the deep learning application. The memory usage pattern may be generated when a first iteration for training the deep learning application is performed. When the memory usage pattern is generated by the first iteration, the electronic device 300 may prefetch a memory according to the memory usage pattern from subsequent iterations. When a memory unit used in the deep learning application is a tensor and a unit of calculation is a kernel, the electronic device 300 may identify a pattern of the kernel based on the memory usage pattern and may identify which tensors are used in the kernel. The electronic device 300 may prefetch tensors based on the identified information from the iterations after the first iteration.

Hereinafter, a method of managing and prefetching tensors by the electronic device 300 is described.

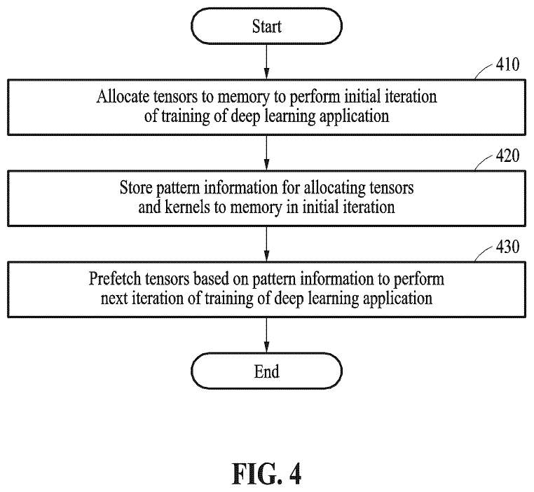

FIG. 4 illustrates an example of a method of operating an electronic device.

In the following examples, operations 410 to 430 may be performed sequentially in the order and manner as shown and described below with reference to FIG. 4, but the order of one or more of the operations may be changed, one or more of the operations may be omitted, and two or more of the operations may be performed in parallel or simultaneously without departing from the spirit and scope of the example embodiments described herein. Operations shown in FIG. 4 may be performed by at least one component of an electronic device (e.g., the electronic device 300).

In operation 410, the electronic device may allocate tensors to a memory to perform an initial iteration of training of a deep learning application.

The deep learning application may perform training “N” times using a training data set. For example, it may be an N-epoch. Each epoch may include a plurality of iterations. A first iteration performed in each epoch may be referred to as the initial iteration. The initial iteration may be performed through an execution of a plurality of kernels. When each kernel is executed, tensors corresponding to each kernel may be used (e.g., to execute the kernels).

In operation 420, the electronic device may store pattern information for allocating the tensors and the kernels to the memory in the initial iteration.

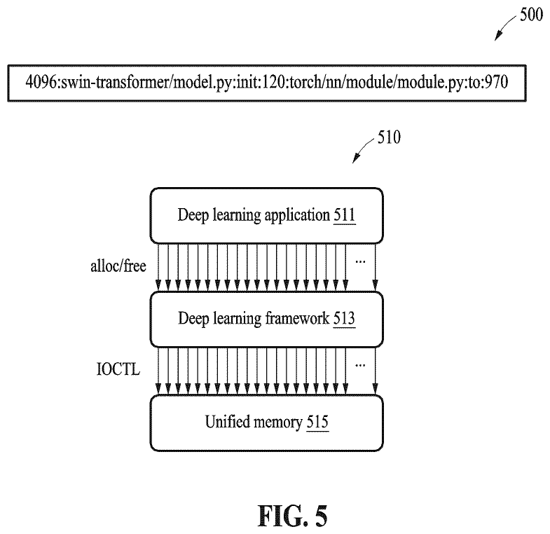

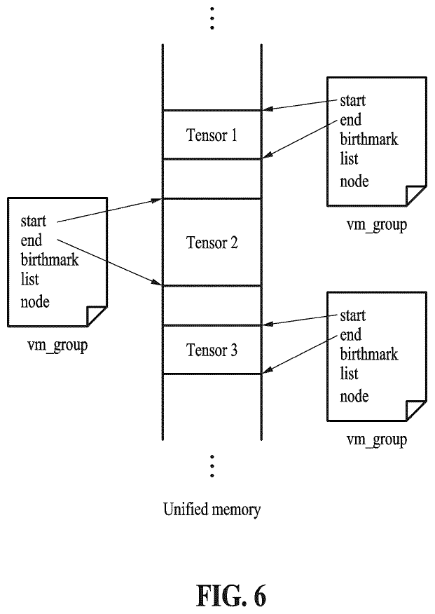

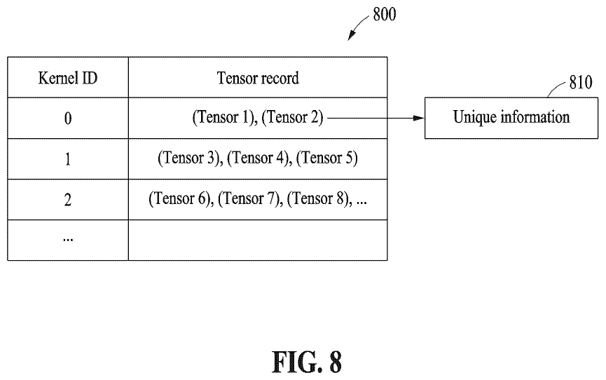

The electronic device may confirm and store the pattern information through the initial iteration. The electronic device may generate unique information about the tensors. An example of a method of generating unique information is further described with reference to FIG. 5. The electronic device may manage the tensors based on the unique information. An example of a method of managing tensors is further described with reference to FIGS. 6 to 8. The electronic device may store the pattern information based on the unique information about the tensors. An example of the pattern information is further described with reference to FIG. 8.

In operation 430, the electronic device may prefetch the tensors based on the pattern information to perform a next iteration of training of the deep learning application.

The next iteration may refer to iterations other than the initial iteration in an epoch. For example, the tensors may be prefetched based on the pattern information in an iteration performed after the initial iteration. An example of a prefetch is further described with reference to FIG. 8. Further, the electronic device may implement the trained deep learning application trained through the operations 410 to 430. For example, the electronic device may implement the trained deep learning application by performing image classification, semantic segmentation, translation, and/or language modeling using the trained deep learning application.

FIG. 5 illustrates an example of unique information of a tensor.

Referring to FIG. 5, a block diagram 510 illustrates an example of unique information 500 of a tensor and transmission of the unique information 500.

As described above, tensors may be allocated to a memory and then may be deallocated from the memory at each iteration. Therefore, when a virtual memory address of a tensor in a next iteration may be different from a virtual memory address of a previous iteration, storing pattern information (i.e., usage pattern) of the tensor using the virtual memory address may not be useful. For example, an electronic device may store the pattern information with a feature for accurately distinguishing between the tensors at each iteration. The electronic device of one or more embodiments may store the pattern information using the unique information 500, which is a feature for accurately distinguishing between the tensors at each iteration. The unique information 500 may also be referred to as a birthmark, since the unique information 500 may be generated when a tensor is allocated to a memory for the first time.

The electronic device may use stack information of a tensor and feature information of a tensor to generate the unique information 500. The stack information of a tensor may be information about a process of allocating the tensor to a memory. For example, the stack information of a tensor may be the stack information of the corresponding process, when the tensor is allocated in the process. For example, to allocate an arbitrary tensor to a memory, when function A calls function B, function B calls function C, function C calls function D, and function D requests allocation of the arbitrary tensor, in this case, the process of calling from function A to function D may be the stack information. The feature information of a tensor may include various properties that may indicate the tensor. For example, the feature information of a tensor may include the size of the tensor. The electronic device may generate the unique information 500 by combining the feature information of a tensor with the stack information of a tensor described above.

Referring to the example of the unique information 500, the unique information 500 may include feature information and stack information of a tensor to which the unique information 500 indicates. According to the feature information of a tensor in the unique information 500, it may be noted that the size of the tensor is 4096 bytes. According to the stack information of a tensor in the unique information 500, it may be noted that “init” function at line 120 of “model.py” file of “swin-tranformer” (i.e., the deep learning application) has requested allocation of the tensor and the tensor has been allocated through “to” function at line 970 of “module.py” file.

Referring to the block diagram 510 from a perspective of a program running on the electronic device, a deep learning application 511 may request a deep learning framework 513 to allocate a tensor. The deep learning framework 513 may allocate a tensor according to the request and may generate the unique information 500 about the tensor. The deep learning framework 513 may transmit the unique information 500 to a unified memory 515 through an input/output control (IOCTL).

Hereinafter, a method of managing tensors using the unique information 500 is described. FIG. 6 illustrates an example of a method of managing tensor information.

An electronic device may manage tensor information as a structure. For example, the electronic device may manage the tensor information with a structure of “vm_group”. However, this is only an example, and other structures may be used to manage tensor information. One structure may be used to manage the tensor information for one tensor. The structure may include a start address (“start” of FIG. 6) of a tensor managed by the structure, an end address (“end” of FIG. 6) of the tensor, and unique information (“birthmark” of FIG. 6). In addition, the structure may further include additional fields for managing the structure. For example, the structure may further include a field (“list” of FIG. 6) for managing the structure as a hash table. The structure may further include a field (“node” of FIG. 6) for managing the structure as a self-balancing binary search tree. Hereinafter, the hash table and the self-balancing binary search tree that manage the structure are described.

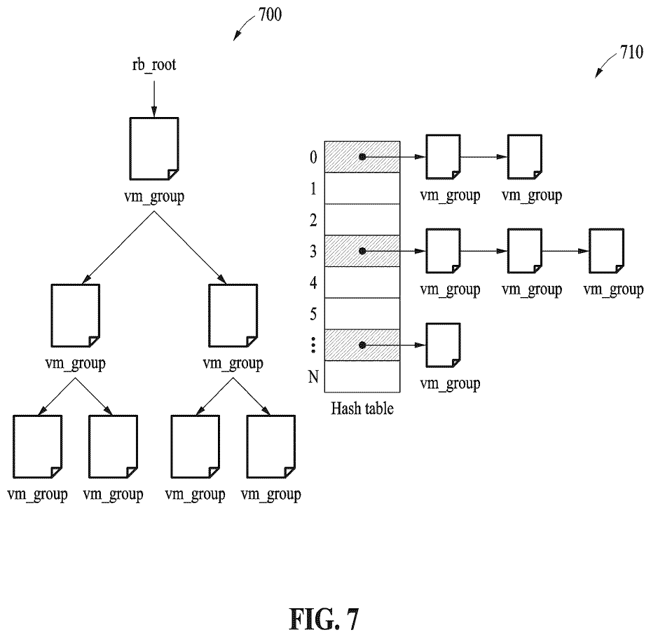

FIG. 7 illustrates an example of management of a tensor.

An electronic device may manage a structure for managing tensor information, using a self-balancing binary search tree. A red-black tree 700 is a representative self-balancing binary search tree capable of performing a range search. Therefore, for ease of description, the description will be made hereinafter using the red-black tree 700. However, it will be understood by one of ordinary skill after an understanding of the present disclosure that the description may be applied to other self-balancing binary search trees as well.

When a page fault occurs, in which data is in a unified memory but has not been loaded into a physical memory (e.g., random access memory (RAM)), the electronic device may use the red-black tree 700 to search for a structure corresponding to an address where the page fault has occurred.

During an initial iteration of training of a deep learning application, tensors may not be loaded into the physical memory. For example, a page fault may always occur for tensors during the initial iteration. The electronic device may use the red-black tree 700 to search for a structure corresponding to tensors in which the page fault has occurred. In addition, the electronic device may generate a tensor table, which is pattern information about the tensor, while searching for the structure during the initial iteration. An example of the tensor table is further described with reference to FIG. 8. In conclusion, the structures may be managed based on the self-balancing binary search tree and the tensor table may be generated.

The electronic device may manage the structures with the self-balancing binary search tree and at the same time, may manage the structures with a hash table 710. While the self-balancing binary search tree is used to quickly search for a structure in which a page fault has occurred, the hash table 710 may be used to search for the structure using unique information of the tensor. Therefore, in the hash table 710, a hash key may be generated based on the unique information of the tensor. The hash key may be mapped to a hash value through a hash function. The hash value may be an index. The number of indexes that may be generated in the hash table 710 may be limited. Therefore, one or more structures may be stored in one index. According to an example, structures used in the same kernel may be stored in the same index. The hash table 710 may be used to prefetch tensors. An example of a method of using the hash table 710 for prefetching is described with reference to FIG. 8.

Hereinafter, the tensor table and the kernel table generated using the above-described self-balancing binary search tree is described, and prefetching of tensors using the tables is described.

FIG. 8 illustrates an example of a tensor table.

Referring to FIG. 8, a tensor table 800 is shown. Before describing the tensor table 800, a kernel table is described.

When the tensor table 800 stores patterns of tensors used in kernels and the kernel table stores execution patterns of kernels, the tensor table 800 and the kernel table may be referred to as pattern information.

When an initial iteration begins, an electronic device may generate a kernel table for storing an execution order of a kernel. Iterations may be performed through sequential execution of kernels. Therefore, the initial iteration may also be performed through sequential execution of the kernels. The electronic device may identify an order of the kernels after the initial iteration is completed. Whenever a kernel is executed, the electronic device may generate a kernel identification (ID) using a name and arguments of the executed kernel. The electronic device may store the execution order of the kernels identified in the initial iteration in the kernel table using the kernel ID.

When the kernels are sequentially executed in the initial iteration, the electronic device may record tensors used in each kernel in the tensor table 800. It may be confirmed which tensors are used in each kernel, according to a page fault pattern. At the initial iteration, the tensors may not be loaded into a physical memory (e.g., RAM), and thus, a page fault may occur each time the kernel is executed. When the page fault occurs, the electronic device may use a self-balancing binary search tree to search for a structure corresponding to the tensors in which the page fault has occurred. The found structure may include unique information 810 of the tensor corresponding to the found structure. The electronic device may store tensors corresponding to each kernel as a tensor table 800. The electronic device may display the tensors as the unique information 810 in the tensor table 800. The order of the kernel ID shown in the tensor table 800 may not be the execution order of the kernel.

For example, referring to the tensor table 800, when a kernel with a kernel ID of 0 is executed, tensor 1 and tensor 2 may be used. Tensor 1 and tensor 2 may be displayed as the unique information 810 in the tensor table 800. For example, referring to the tensor table 800, when a kernel with a kernel ID of 1 is executed, tensor 3, tensor 4, and tensor 5 may be used. Tensor 3, tensor 4, and tensor 5 may be displayed as the unique information 810 in the tensor table 800.

In training of a deep learning application, since memory usage always shows the same pattern in each iteration, the tensor table 800 and the kernel table generated according to the initial iteration may be used to prefetch the tensors in a next iteration.

The electronic device may perform prefetching to perform the next iteration, based on the kernel table and the tensor table 800 described above. The next iteration may be an arbitrary iteration performed after the initial iteration.

When a kernel is executed according to the start of the next iteration, the electronic device may confirm tensors used to execute the kernel through the tensor table 810. The electronic device may confirm the unique information 810 of one or more tensors used to execute the kernel through the tensor table 810. The electronic device may obtain structures corresponding to the one or more tensors confirmed in a hash table using the unique information 810 of the one or more tensors confirmed. The electronic device may use the information included in the structures to prefetch the one or more tensors confirmed to a memory.

In addition, the electronic device may predict the next kernel to be executed using the kernel table. The electronic device may use the tensor table 800 to confirm the unique information 810 of one or more tensors used in the next kernel to be executed. Subsequently, the above-described method may be applied. Accordingly, the electronic device may prefetch the tensors corresponding to the next kernels to be executed to a memory. In the present disclosure, tensors corresponding to a kernel may refer to the tensors used for execution of the corresponding kernel.

In conclusion, the electronic device of one or more embodiments may predict the kernels to be executed based on the kernel table and the tensor table 800 and may proactively prefetch the tensors corresponding to the predicted kernels.

The unified memory systems, electronic devices, host processors, memories, accelerators, unified memories, unified memory system 100, unified memory system 110, electronic device 300, host processor 310, memory 320, accelerator 330, and unified memory 515 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
allocating tensors to a memory to perform an initial iteration of training of a deep learning application, wherein the initial iteration is performed through execution of a plurality of kernels and, in response to each kernel being executed, tensors corresponding to the each kernel are used to execute the kernels;
storing pattern information for allocating the tensors and the kernels to the memory in the initial iteration; and
prefetching the tensors based on the pattern information to perform a next iteration of training of the deep learning application.

2. The method of claim 1, wherein the storing of the pattern information for allocating the tensors and the kernels to the memory comprises:
generating unique information of the tensors; and
generating and storing the pattern information based on the unique information.

3. The method of claim 2, wherein the unique information comprises feature information of a tensor and stack information about a process of allocating the tensor to the memory.

4. The method of claim 1, wherein the pattern information comprises a kernel table for storing an execution order of the kernels in the initial iteration and a tensor table for storing tensors corresponding to the each kernel.

5. The method of claim 4, wherein the prefetching of the tensors comprises predicting kernels to be executed based on the kernel table and the tensor table and prefetching tensors corresponding to the predicted kernels.

6. The method of claim 5, wherein the tensor table is generated through a search using a self-balancing binary search tree.

7. The method of claim 2, further comprising managing the tensors with structures including the unique information.

8. The method of claim 7, wherein the managing of the tensors comprises, in response to a page fault occurring, managing the structures with a self-balancing binary search tree for searching for a structure in which the page fault occurred and managing the structures with a hash table to search for a tensor using the feature information.

9. The method of claim 1, further comprising training the deep learning application using the prefetched tensors.

10. A processor-implemented method comprising implementing the trained deep learning application, wherein the deep learning application is trained by the method of claim 1.

11. A non-transitory computer-readable storage medium storing instructions that, when executed by one or more processors, configure the one or more processors to perform the method of claim 1.

12. A processor-implemented method comprising:
allocating tensors to a memory to perform an initial iteration of training of a deep learning application, wherein the initial iteration is performed through execution of a plurality of kernels and, in response to each kernel being executed, tensors corresponding to the each kernel are used to execute the kernels;
obtaining unique information of the tensors through the initial iteration;
storing pattern information for allocating the tensors and the kernels to the memory based on the unique information; and
prefetching the tensors based on the pattern information to perform a next iteration of training of the deep learning application,
wherein the unique information comprises feature information of a tensor and stack information about a process of allocating the tensor to the memory.

13. An electronic device comprising:
one or more processors configured to:
allocate tensors to a memory to perform an initial iteration of training of a deep learning application, wherein the initial iteration is performed through execution of a plurality of kernels and in response to each kernel being executed, tensors corresponding to the each kernel are used to execute the kernels;
store pattern information for allocating the tensors and the kernels to the memory in the initial iteration; and
prefetch the tensors based on the pattern information to perform a next iteration of training of the deep learning application.

14. The electronic device of claim 13, wherein, for the storing of the pattern information for allocating the tensors and the kernels to the memory, the one or more processors are configured to generate unique information of the tensors and generate and store the pattern information based on the unique information.

15. The electronic device of claim 14, wherein the unique information comprises feature information of a tensor and stack information about a process of allocating the tensor to the memory.

16. The electronic device of claim 13, wherein the pattern information comprises a kernel table for storing an execution order of the kernels in the initial iteration and a tensor table for storing tensors corresponding to the each kernel.

17. The electronic device of claim 16, wherein, for the prefetching of the tensors, the one or more processors are configured to predict kernels to be executed based on the kernel table and the tensor table and prefetch tensors corresponding to the predicted kernels.

18. The electronic device of claim 17, wherein the tensor table is generated through a search using a self-balancing binary search tree.

19. The electronic device of claim 14, wherein, the one or more processors are configured to manage the tensors with structures including the unique information.

20. The electronic device of claim 19, wherein, for the managing of the tensors, the one or more processors are configured to, in response to a page fault occurring, manage the structures with a self-balancing binary search tree for searching for a structure in which the page fault occurred and manage the structures with a hash table to search for a tensor using the feature information.
